(19) United States
(12) Patent Application Publication
(10) Pub. No.: US 2025/0331460 A1
(43) Pub. Date: Oct. 30, 2025

(54) ROTARY PIVOT MECHANISM FOR CONVEYOR OF SUGARCANE HARVESTER

(71) Applicant: DEERE & COMPANY, MOLINE, IL (US)

(72) Inventors: Mahadev S. Pansare, PUNE (IN); KENT M. ALMEIDA, NAPOLEONVILLE, LA (US); Mark S. Louviere, Houma, LA (US)

(21) Appl. No.: 18/644,173

(22) Filed: Apr. 24, 2024

(51) Int. Cl. A01D 61/00; A01D 45/10

(52) U.S. Cl. CPC A01D 61/00; A01D 45/10

(57) ABSTRACT

A sugarcane harvester includes a support structure, an elevator, and a slewing bearing attaching the elevator to the support structure. The slewing bearing includes a first ring attached to the elevator, and a second ring attached to the support structure. An actuator is operatively coupled to the slewing bearing for rotating the first ring and the elevator relative to the second ring and the support structure. The slewing bearing may be attached to a primary extractor frame of the support structure, vertically above the lower receiving portion of the elevator.

### TECHNICAL FIELD

The disclosure generally relates to a sugarcane harvester.

### BACKGROUND

Sugarcane harvesters often have a basecutter assembly positioned to sever sugarcane stalks adjacent a ground surface, and convey the sugarcane stalks to a chopper. The chopper cuts the sugarcane stalks into billets and ejects or discharges the billets into the air and towards an elevator. A primary extractor is positioned between the chopper and the elevator to induce a flow of air through the billets for removing unwanted leaf material and other debris from the flow of billets as the billets move through the air between the chopper and the elevator. Once ejected from the chopper, gravity acts on the billets causing the billets to fall vertically downward as the primary extractor removes the leaf material. The elevator includes a lower receiving portion positioned to capture or catch the billets ejected from the chopper. The lower receiving portion of the elevator is positioned lower in the sugarcane harvester, relative to the ground surface, to provide a vertical distance between the primary extractor and the lower receiving portion of the elevator so that the billets separate and the flow of air induced by the primary extractor may operate to separate and/or remove the leaf material. The elevator includes a lift portion extending upward from the lower receiving portion and away from the sugarcane harvester. The lift portion is arranged to raise or lift the billets to a higher elevation for discharge into a wagon for transport to a mill. The elevator is typically rotatably moveable relative to the sugarcane harvester about a generally vertical axis to properly position the upper end of the elevator for discharging the billets into the wagon.

Typically, the elevator is supported by a swing table disposed below the lower receiving portion of the elevator. The swing table is controlled by a pair of hydraulic cylinders and corresponding hydraulic system components.

### SUMMARY

A sugarcane harvester is provided. The sugarcane harvester includes a support structure. A first ring and a second ring are rotatably coupled to each other for rotation about a central axis of rotation. The second ring is attached to the support structure. The sugarcane harvester includes an elevator configured for lifting sugarcane billets from a lower receiving elevation to an upper discharge elevation. The elevator is coupled to the first ring. As such, the first ring and the second ring form a slewing bearing interconnecting the support structure and the elevator.

In one aspect of the disclosure, the support structure includes a primary extractor frame that is configured for supporting a primary extractor assembly. The second ring is attached to the primary extractor frame.

In one aspect of the disclosure, the elevator includes a lower receiving portion and a lift portion. The lower receiving portion is disposed at the lower receiving elevation, adjacent the ground surface. The lower receiving portion of the elevator is arranged generally horizontally relative to the ground surface for receiving the sugarcane billets. In one implementation of the disclosure, the first ring and the second ring are disposed vertically above the lower receiving portion of the elevator. The lift portion of the elevator extends outward and upward from the lower receiving portion of the elevator, and is configured for raising or lifting the billets from the lower receiving elevation to an upper end of the elevator defining a discharge elevation.

In one aspect of the disclosure, the sugarcane harvester includes an actuator. The actuator is attached to the support structure and is operatively engaged with the first ring for rotating the first ring and the elevator about the central axis of rotation.

In one aspect of the disclosure, the sugarcane harvester includes a torque transmitting system interconnecting the actuator and the first ring.

In one implementation, the torque transmitting system may include a pinion gear mounted to an output of the actuator and a driven gear surface coupled to the first ring. The driven gear surface may be mounted directly on and/or formed by the first ring. In other implementations, the driven gear surface may be mounted on and/or defined by a support bracket fixedly attached to the first ring.

In one implementation of the torque transmitting system, the pinion gear and the driven gear surface are disposed in direct meshing engagement. In another implementation, the torque transmitting system may include a flexible connector connected to each of and interconnecting the pinion gear and the driven gear surface. For example, the flexible connector may include, but is not limited to, a chain drive or a belt drive.

In one aspect of the disclosure, the actuator may include, but is not limited to, one of a hydraulically driven motor or an electrically driven motor. The actuator may be selectively controlled to rotate and output in either a first rotational direction or an opposite second rotational direction to thereby rotate the first ring and the elevator in either the first rotational direction or the second rotational direction respectively.

In one aspect of the disclosure, a support bracket may interconnect the first ring and the elevator. The support bracket may include, for example, a ring connection portion fixedly attached to the first ring. The ring connection portion may define a fully annular or circular mount, or a portion of an annular or circular mount, i.e., a semi-circular mount. The bracket may further include a leg portion extending from the ring connection portion to a distal end. The elevator may be fixedly attached to the leg portion proximate the distal end thereof to define a first elevator support connection. The leg portion of the support bracket may extend in generally vertical downward direction from the ring connection portion toward the lower receiving portion of the elevator. In one implementation, the leg portion includes a first leg portion disposed on a first lateral side of the elevator, and a second leg portion disposed on an opposite second lateral side of the elevator, opposite the first leg portion.

In one aspect of the disclosure, the support bracket may include a link interconnecting one of the ring connection portion or the leg portion with the elevator to define a second elevator support connection. In one implementation, the second elevator support connection is disposed vertically above and spaced apart from the first elevator support connection. In one implementation, the link may include a first link disposed on the first lateral side of the elevator, and a second link disposed on the opposite second lateral side of the elevator, opposite the first link.

Accordingly, the slewing bearing described herein connects the elevator to the support structure of the sugarcane harvester. The slewing bearing uses only a single actuator to rotate the elevator, thereby reducing the number of hydraulic lines and hydraulic cylinders typically used to rotate the elevator in prior art harvesters. Additionally, the slewing bearing may be positioned above the lower receiving portion of the elevator, for example, attached to and supported by the primary extractor frame. As such, the elevator is attached to and supported by the support structure at a location disposed above the lower receiving portion of the elevator, thereby eliminating the swing table from below the lower receiving portion of the elevator common in prior art harvesters. In one implementation of the disclosure, eliminating the swing table from below the lower receiving portion of the elevator increases ground clearance between the lower receiving portion of the elevator and the ground surface, thereby improving maneuverability of the sugarcane harvester. In another implementation of the disclosure, eliminating the swing table from below the lower receiving portion of the elevator enables the lower receiving portion of the elevator to be lowered relative to the ground surface without reducing ground clearance at the rear of the sugarcane harvester. Such a configuration increases the vertical distance between the lower receiving portion of the elevator and the primary extractor thereby improving operational efficiency of the primary extractor.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a sugarcane harvester.

FIG. 2 is a schematic partial perspective view of the sugarcane harvester viewed from the rear.

FIG. 3 is a schematic partial exploded perspective view of the sugarcane harvester showing a first embodiment of a torque transmitting system.

FIG. 4 is a schematic perspective view of a slewing bearing and an elevator support bracket of the sugarcane harvester showing the first embodiment of the torque transmitting system.

FIG. 5 is a schematic partial cross-sectional view of the sugarcane harvester showing the first embodiment of the torque transmitting system.

FIG. 6 is a schematic perspective view of the slewing bearing and the elevator support bracket of the sugarcane harvester showing a second embodiment of the torque transmitting system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

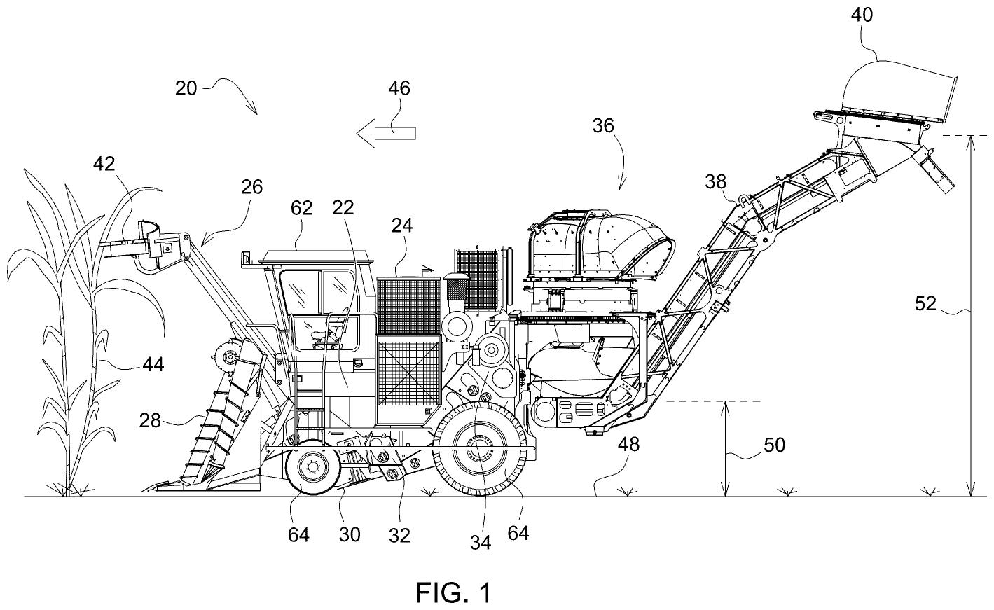

Referring to the Figures, wherein like numerals indicate like parts throughout the several views, a sugarcane harvester is generally shown at 20. Referring to FIG. 1, the sugarcane harvester 20 includes a main frame, which may be referred to herein as the support structure 22. The support structure 22 supports various cutting, routing and processing devices. An engine 24 may supply power for driving the sugarcane harvester 20 and for powering various driven components of the sugarcane harvester 20. In certain embodiments, the engine 24 may directly power a main hydraulic pump (not shown). Various driven components of the sugarcane harvester 20 may be powered by hydraulic motors receiving hydraulic power from the main hydraulic pump via one or more hydraulic loops (not shown).

Referring to FIG. 1, among other components and features, some of which are not described herein, the sugarcane harvester 20 may include a topper assembly 26, a left and a right crop divider scroll 28 (the left crop divider scroll is not shown), an upper knockdown roller and a lower knockdown roller (the upper and lower knockdown rollers are not shown), a basecutter assembly 30, a feed section 32, a chopping section or chopper 34, a primary extractor 36, an elevator 38, and a secondary extractor 40.

The topper assembly 26 is mounted to the support structure 22. The topper assembly 26 includes a cantilevered arm structure attached to the support structure 22. The cantilevered arm extends from the support structure 22 to a distal end thereof, in a generally forward direction relative to a direction of travel 46 during operation, and a generally upward direction relative to a ground surface 48. The topper assembly 26 includes a top cutter 42 supported by the cantilevered arm proximate the distal end of the cantilevered arm. The top cutter 42 is positioned for severing an upper leaf portion of a sugarcane plant 44 from a central stalk portion of the sugarcane plant 44. The top cutter 42 may include a blade or other cutting device and/or system configured for cutting the sugarcane plant 44. The particular components, structure and operation of the top cutter 42 are understood by those skilled in the art, and are therefore not described in greater detail herein.

The left and right crop divider scrolls 28 are adapted to lift the sugarcane plants 44 for feeding into a throat of the sugarcane harvester 20. The upper and lower knockdown rollers are adapted to lean standing sugarcane plants 44 in the forward direction relative to the direction of travel 46 of the sugarcane harvester 20 during operation.

The basecutter assembly 30 is mounted to the support structure 22 adjacent the ground surface 48. The basecutter assembly 30 includes a cutting disk or other cutting device that is configured for severing the sugarcane plants 44 adjacent a ground surface 48. The basecutter assembly 30 is operable to sever a central stalk portion of the sugarcane plant 44 from a bottom root portion of the sugarcane plant 44. The basecutter assembly 30 is adapted to sever the sugarcane plants 44 knocked down or leaned over in the forward direction by the upper and lower knockdown rollers. Additionally, the basecutter assembly 30 is operable to move and/or feed the central stalk portion of the sugarcane plant 44 to the feed section 32.

The feed section 32 is adapted to receive a mat of severed sugarcane crop material from the basecutter assembly 30, and to move the mat of crop material rearwardly for further processing. The feed section 32 may include, for example, successive pairs of upper and lower feed rollers rotatably supported by the support structure 22. At least one pair of the upper and lower feed rollers may be powered to transport the mat of the cut sugarcane crop material to the chopper 34.

The chopper 34 is adapted to receive the mat from the feed section 32 and to cut the sugarcane plant 44 into billets. The chopper 34 may include, for example, a drum configured for cutting the stalks of sugarcane into billets. The primary extractor 36 is positioned downstream from the chopper 34 and is adapted to separate debris, including, for example, crop residue (e.g., leafy material), from the billets and remove the debris from the sugarcane harvester 20.

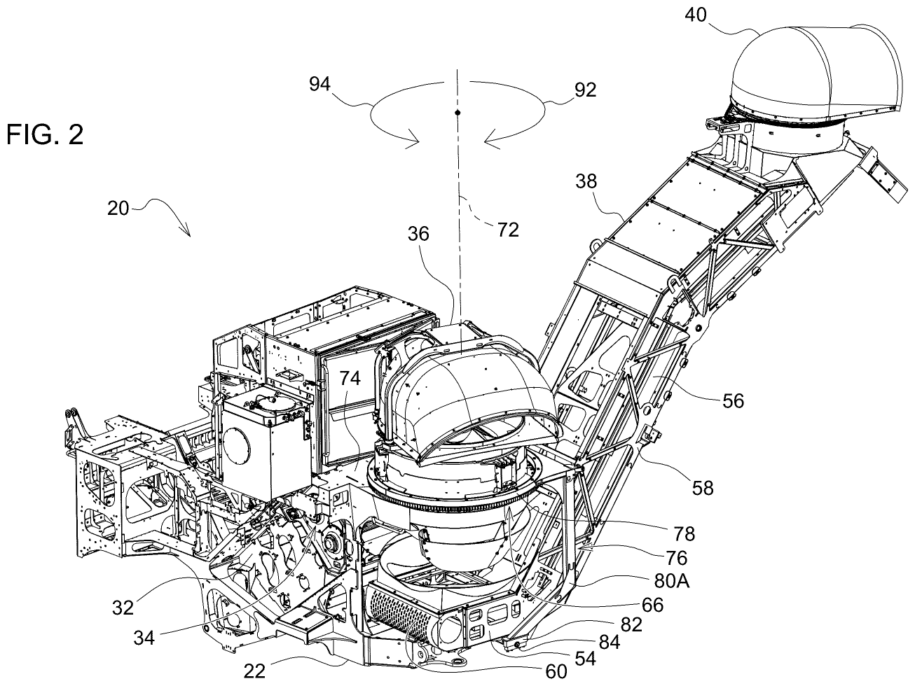

Referring to FIGS. 1 and 2, the elevator 38 is positioned at the rear of the sugarcane harvester 20 to receive the cleaned flow of billets, and is adapted to convey the billets to an elevated position where the billets are discharged into a transport vehicle to be hauled away. The elevator 38 is configured for lifting the sugarcane billets from a lower receiving elevation 50 to an upper discharge elevation 52. As described above, once ejected from the chopper 34, gravity acts on the billets causing the billets to fall vertically downward as the primary extractor 36 removes the leaf material. The elevator 38 includes a lower receiving portion 54 positioned to capture or catch the billets ejected from the chopper 34. The lower receiving portion 54 of the elevator 38 is positioned lower in the sugarcane harvester 20 relative to the ground surface 48, at the lower receiving elevation 50, to provide a vertical distance between the primary extractor 36 and the lower receiving portion 54 of the elevator 38 so that the billets separate and the flow of air induced by the primary extractor 36 may operate to separate and/or remove the debris. The elevator 38 includes a lift portion 56 extending upward from the lower receiving portion 54 and away from the sugarcane harvester 20. The lift portion 56 is arranged to raise or lift the billets to a higher elevation for discharge into a wagon for transport to a mill.

As is understood in the art, the elevator 38 may include an elevator frame 58 that rotatably supports an endless device 60, such as but not limited to a conveyor belt. The conveyor belt may include flighting or other similar structure to engage the billets and move the billets up the lift portion 56 of the elevator 38.

The secondary extractor 40 (some embodiments may not have a secondary extractor 40) is positioned near the top of the elevator 38, and is adapted to further separate debris from the billets and to remove the debris from the sugarcane harvester 20, as is understood by those skilled in the art.

Referring to FIG. 1, the sugarcane harvester 20 may include an operator station 62 and traction elements 64. The various user input and control devices, data output devices, etc., may be located within the operator station 62. A human operator may operate the sugarcane harvester 20 from the operator station 62. In certain embodiments, the support structure 22 may be supported by a transport frame such as track frame supporting the traction elements 64. The traction elements 64 are positioned on the left and right sides of the sugarcane harvester 20 for propelling the sugarcane harvester 20 through a field and along the ground surface 48. Each traction element 64 may include, but are not limited to, a track unit or a ground-engaging wheel.

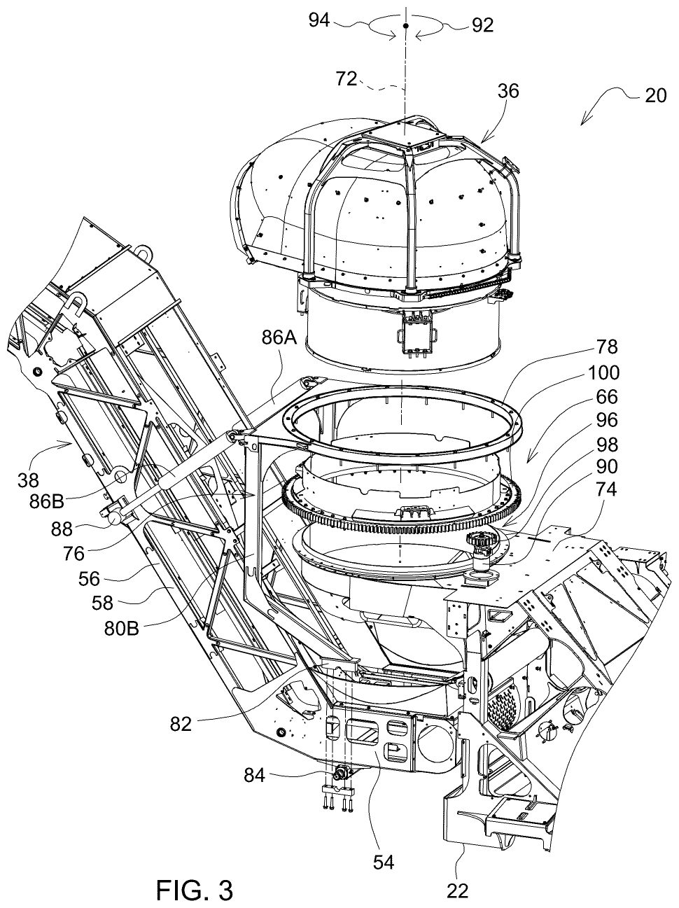

Referring to FIGS. 2-5, the sugarcane harvester 20 includes a slewing bearing 66 interconnecting the support structure 22 and the elevator 38. The slewing bearing 66 may alternatively be referred to as a turntable bearing, and may be considered a rotational roller-element bearing. The slewing bearing 66 includes a first ring 68 and a second ring 70 rotatably coupled to each other for rotation about a central axis of rotation 72. The first ring 68 may be referred to as an outer bearing race, and the second ring 70 may be referred to as an inner bearing race. The slewing bearing 66 may further include multiple trapped roller elements, e.g., roller pins or roller balls, separating the first ring 68 and the second ring 70 for reducing friction therebetween as is understood in the art.

While the first ring 68 is depicted in the Figures having a fully circular or annular configuration, it should be appreciated that the first ring 68 may be configured to be semi-circular and/or non-circular in shape. Similarly, while the second ring 70 is depicted in the Figures having a fully circular or annular configuration, it should be appreciated that the second ring 70 may be configured to be semi-circular and/or non-circular in shape.

In the example implementation shown in the Figures and described herein, the second ring 70 is fixedly attached to the support structure 22, and the first ring 68 is fixedly attached to the elevator 38. In one implementation, the support structure 22 may include a primary extractor frame 74 that is configured for supporting the primary extractor 36. The second ring 70 may be fixedly attached to the primary extractor frame 74. For example, the second ring 70 may be attached to the primary extractor frame 74 about or around an exterior circumference of the primary extractor 36, i.e., with the primary extractor 36 disposed within an interior space of the second ring 70. The second ring 70 may be bolted, welded, or otherwise secured or fastened to the primary extractor frame 74. While the example implementation shown in the Figures and described herein shows the second ring 70 mounted to the primary extractor frame 74, it should be appreciated that the second ring 70 may be mounted to some other portion of the support structure 22 at another location of the sugarcane harvester 20 not specifically mentioned or described herein.

A support bracket 76 may interconnect the first ring 68 and the elevator 38. In the example implementation shown in the Figures and described herein, the support bracket 76 includes a ring connection portion 78 that is fixedly attached to the first ring 68. The ring connection portion 78 may be bolted, welded, or otherwise secured or fastened to the first ring 68 of the slewing bearing 66.

The support bracket 76 may further include a leg portion 80A, 80B. The leg portion 80A, 80B may extend from the ring connection portion 78 to a distal end 82. For example, the leg portion 80A, 80B may extend from the ring connection portion 78 vertically downward toward the ground surface 48. The elevator 38 may be fixedly attached to the leg portion 80A, 80B proximate the distal end 82 of the leg portion 80A, 80B to define a first elevator support connection 84. In the example implementation, the lower receiving portion 54 of the elevator 38 is attached to the distal end 82 of the leg portion 80A, 80B of the support bracket 76 to position the lower receiving portion 54 at the lower receiving elevation 50. As shown, the leg portion 80A, 80B includes a first leg portion 80A disposed on a first lateral side of the elevator 38, and a second leg portion 80B disposed on a second lateral side of the elevator 38, opposite the first leg portion 80A. In this configuration, the elevator 38 may be considered to hang from the first ring 68, and is not supported and/or attached to the support structure 22 from below. While the example implementation shown in the Figures and described herein shows the elevator 38 mounted to the first ring 68 via the support bracket 76, it should be appreciated that the elevator 38 may be mounted to the first ring 68 directly or in some other manner using other configurations of the support bracket 76 and/or structural elements not specifically mentioned or described herein.

In one implementation, the support bracket 76 may include a link 86A, 86B interconnecting one of the ring connection portion 78 or the leg portion 80A, 80B, with the elevator 38. The link 86A, 86B defines a second elevator support connection 88. For example, the second elevator support connection 88 may be positioned above the first elevator support connection 84 to provide stability and reduce bending forces in the leg portion 80A, 80B of the support bracket 76. As shown, the link 86A, 86B includes a first link 86A disposed on the first lateral side of the elevator 38, and a second link 86B disposed on the second lateral side of the elevator 38, opposite the first link 86A. In one implementation, the first link 86A and the second link 86B may each include a respective linear actuator, such as but not limited to hydraulic cylinders, operable to extend and retract for raising and lowering the elevator 38.

As described above, the elevator 38 includes the lower receiving portion 54 disposed at the lower receiving elevation 50. The lower receiving portion 54 is arranged generally horizontally relative to the ground surface 48 for receiving the sugarcane billets from the chopper 34. In the implementation shown in the Figures and described herein, the slewing bearing 66, including both the first ring 68 and the second ring 70, is disposed vertically above the lower receiving portion 54 of the elevator 38. By suspending the lower receiving portion 54 of the elevator 38 from the slewing bearing 66 via the support bracket 76, thereby eliminating a swing table support from below the elevator 38, ground clearance at the rear of the sugarcane harvester 20 may be increased, or alternatively, the lower receiving portion 54 of the elevator 38 may be lowered.

An actuator 90 is attached to the support structure 22. The actuator 90 is operatively engaged with the first ring 68 for rotating the first ring 68 and the elevator 38 about the central axis of rotation 72. The central axis of rotation 72 may include, for example, a diametric center of the slewing bearing 66. The actuator 90 may include, but is not limited to, one of a hydraulically driven motor or an electrically driven motor. The actuator 90 may be controlled to rotate the first ring 68 and the elevator 38 relative to the second ring 70 and the support structure 22 in a first rotational direction 92, e.g., a clockwise direction, and in an opposite second rotational direction 94, e.g., a counter-clockwise direction.

A torque transmitting system 96 interconnects the actuator 90 and the first ring 68. In the example implementation shown in the Figures and described herein, the torque transmitting system 96 includes a pinion gear 98 mounted to an output of the actuator 90 and a driven gear surface 100 coupled to the first ring 68. However, it should be appreciated that the torque transmitting system 96 may differ from the example implementation described herein, and need not include the pinion gear 98 and/or the driven gear surface 100.

In one implementation, the driven gear surface 100 is be disposed on the first ring 68. The driven gear surface 100 may be integrally formed with the first ring 68, or a separate component fixedly attached to the first ring 68. In another implementation, the driven gear surface 100 may be disposed on the support bracket 76, e.g., the ring connection portion 78 of the support bracket 76. The driven gear surface 100 may be integrally formed with the support bracket 76, or may be a separate component fixedly attached to the support bracket 76. The driven gear surface 100 may be formed to define a complete annular gear surface, or a partial annular gear surface.

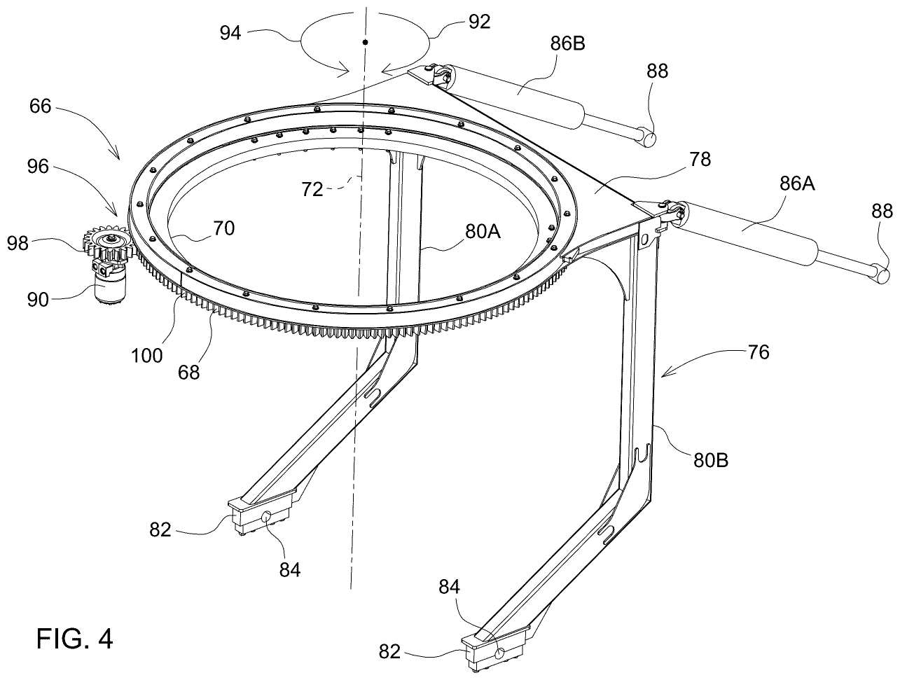

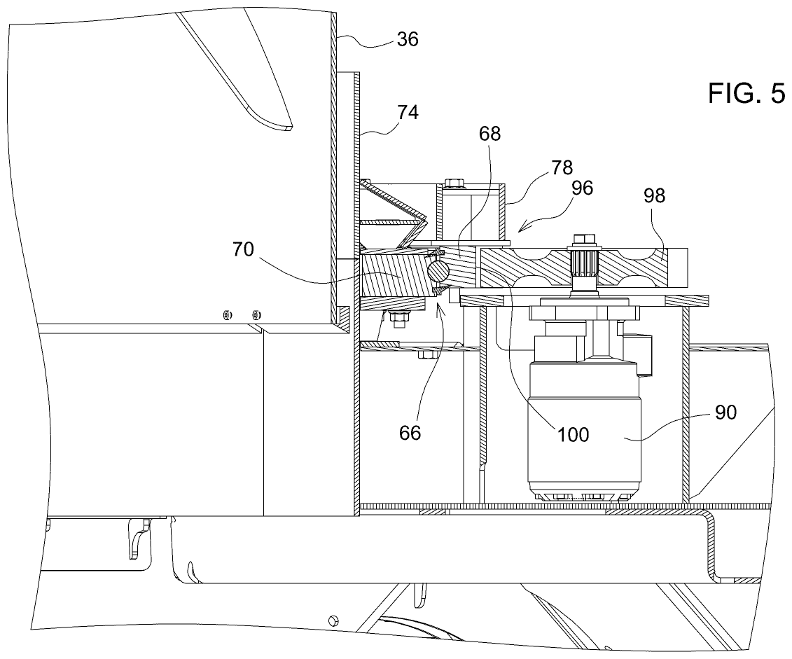

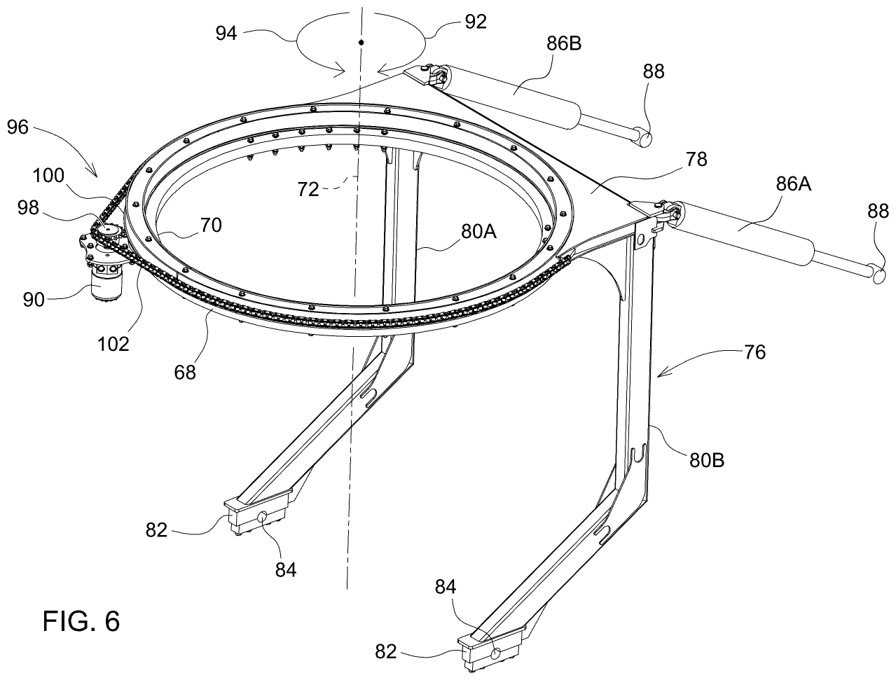

In one implementation, shown in FIGS. 4 and 5, the pinion gear 98 and the driven gear surface 100 are disposed in direct meshing engagement. In another implementation, shown in FIG. 6, the torque transmitting system 96 includes a flexible drive connector 102 coupled to each of the pinion gear 98 and the driven gear surface 100. The flexible drive connector 102 is operable to transmit torque between the pinion gear 98 of the actuator 90 and the driven gear surface 100 of the slewing bearing 66. For example, the flexible drive connector 102 may include, but is not limited to, one of a chain or a belt.

It should be appreciated that the torque transmitting system 96 may be configured differently than the example implementation described herein. For example, the torque transmitting system 96 may include a pulley and belt system connecting the actuator 90 and the slewing bearing 66, a gear reduction drivetrain, etc.

It should be appreciated that the sugarcane harvester 20 may be configured differently than the example implementation shown in the Figures and described herein. Particularly, the slewing bearing 66 may be positioned differently within the sugarcane harvester 20, and the components connecting the slewing bearing 66 to the support structure 22 and the elevator 38 may differ from the example implementation. For example, the slewing bearing 66 may be disposed below the lower receiving portion 54 of the elevator 38.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A sugarcane harvester comprising:
a support structure;
a first ring and a second ring rotatably coupled to each other for rotation about a central axis of rotation, wherein the second ring is attached to the support structure;
an elevator configured for lifting sugarcane billets from a lower receiving elevation to an upper discharge elevation; and
wherein the elevator is coupled to the first ring.

2. The sugarcane harvester set forth in claim 1, wherein the support structure includes a primary extractor frame configured for supporting a primary extractor assembly, with the second ring attached to the primary extractor frame.

3. The sugarcane harvester set forth in claim 1, wherein the elevator includes a lower receiving portion disposed at the lower receiving elevation and arranged generally horizontally relative to a ground surface for receiving the sugarcane billets, with the first ring and the second ring disposed vertically above the lower receiving portion of the elevator.

4. The sugarcane harvester set forth in claim 1, further comprising an actuator attached to the support structure and operatively engaged with the first ring for rotating the first ring and the elevator about the central axis of rotation.

5. The sugarcane harvester set forth in claim 4, further comprising a torque transmitting system interconnecting the actuator and the first ring.

6. The sugarcane harvester set forth in claim 5, wherein the torque transmitting system includes a pinion gear mounted to an output of the actuator and a driven gear surface coupled to the first ring.

7. The sugarcane harvester set forth in claim 6, wherein the pinion gear and the driven gear surface are disposed in direct meshing engagement.

8. The sugarcane harvester set forth in claim 6, wherein the torque transmitting system includes a flexible drive connector coupled to each of the pinion gear and the driven gear surface.

9. The sugarcane harvester set forth in claim 8, wherein the flexible drive connector includes one of a chain or a belt.

10. The sugarcane harvester set forth in claim 4, wherein the actuator includes one of a hydraulically driven motor or an electrically driven motor.

11. The sugarcane harvester set forth in claim 1, further comprising a support bracket interconnecting the first ring and the elevator.

12. The sugarcane harvester set forth in claim 11, wherein the support bracket includes a ring connection portion fixedly attached to the first ring.

13. The sugarcane harvester set forth in claim 12, wherein the support bracket includes a leg portion extending from the ring connection portion to a distal end, with the elevator fixedly attached to the leg portion proximate the distal end thereof to define a first elevator support connection.

14. The sugarcane harvester set forth in claim 13, wherein the support bracket includes a link interconnecting one of the ring connection portion or the leg portion with the elevator to define a second elevator support connection.

15. The sugarcane harvester set forth in claim 13, wherein the leg portion of the support bracket extends in generally vertical downward direction from the ring connection portion.

16. A sugarcane harvester comprising:
a support structure;
a basecutter assembly having a cutting disk configured for severing stalks of sugarcane adjacent a ground surface;
a chopper having a drum configured for cutting the stalks of sugarcane into billets;
an extractor configured for separating leaf material from the sugarcane billets;
an elevator having a lower receiving portion arranged for receiving the sugarcane billets from the chopper, and a lift portion extending vertically upward from the lower receiving portion for lifting the sugarcane billets; and
a slewing bearing interconnecting the support structure and the elevator.

17. The sugarcane harvester set forth in claim 16, wherein the slewing bearing includes a first ring and a second ring rotatably coupled to each other for rotation about a central axis of rotation, wherein the second ring is attached to the support structure, and wherein the first ring is attached to the elevator.

18. The sugarcane harvester set forth in claim 17, further comprising a support bracket interconnecting the first ring and the elevator, wherein the support bracket includes a ring connection portion fixedly attached to the first ring, and a leg portion extending from the ring connection portion to a distal end, with the elevator fixedly attached to the leg portion proximate the distal end thereof.

19. The sugarcane harvester set forth in claim 16, further comprising an actuator attached to the support structure and operatively engaged with the slewing bearing for rotating the elevator about a central axis of rotation of the slewing bearing.

20. The sugarcane harvester set forth in claim 16, wherein the slewing bearing attaching the elevator to the support structure is positioned vertically above the lower receiving portion of the elevator relative to the ground surface.
